(19) United States
(12) Patent Application Publication
(10) Pub. No.: US 2010/0325015 A1
(43) Pub. Date: Dec. 23, 2010

(54) SYSTEM AND METHOD FOR USING IMAGE DATA TO PROVIDE SERVICES IN CONNECTION WITH AN ONLINE RETAIL ENVIRONMENT

(75) Inventor: Geoffry A. Westphal, Evanston, IL (US)

Correspondence Address: GREENBERG TRAURIG, LLP, 77 WEST WACKER DRIVE, SUITE 3100, CHICAGO, IL, 60601-1732, US

(73) Assignee: W.W. GRAINGER, INC., Lake Forest, IL (US)

(21) Appl. No.: 12/487,449

(22) Filed: Jun. 18, 2009

(51) Int. Cl. G06Q 30/00; G06Q 99/00

(52) U.S. Cl. 705/27; 705/1.1

(57) ABSTRACT

An image recognition system is provided with a reference image and the image recognition system functions to discern a context for the reference image. A user is thereafter presented with recommendations for products or other online services that are relevant to the discerned context for the image.

### BACKGROUND

In the art it is known to use data within an image that is provided to a server in an online environment to identify similar images. Examples of such online functionality may be found at websites such as “images.googlelabs.com,” “like.com,” and “gazopa.com.” In operation, a user generally uploads an image to such websites and the websites use well-known imaging technologies to compare the uploaded image to other images found in a data repository in an attempt to locate images within the data repository that are similar in one more characteristics to the uploaded image. By way of further example, Apples' “iPhoto '09” provides a feature that uses imaging technologies to locate images in a data repository that appear to have the same person to thereby allow a user to organize images in the data repository.

It is also know in the art to use imaging technologies to identify specific objects that are found within an image. For example, the website “snaptell.com” provides a service by which a user uploads a picture of a CD cover, DVD cover, book cover, video game cover, or the like whereupon the “snaptell.com” server uses the image to locate and provide to the user information, such as purchase locations, prices, and reviews, for the particular book, CD, DVD, etc. that was discerned by the server as being shown in uploaded image. Similarly, U.S. Published Patent Application Nos. 2007/0279244 and 2007/0096283 discloses systems in which a user uploads to a server an image of an object such as an appliance whereupon the server uses the image to locate and provide to the user configuration information for programming a remote control to control an appliance that was discerned by the server as being shown in the uploaded image.

### SUMMARY OF THE INVENTION

The following generally describes a system and method for using image data, e.g., video, photos, drawings, etc., in connection with a process for providing online retail services. In the system and method described hereinafter, an image uploaded to a server is processed using imaging technologies to locate similar images. Thereafter, using information that has been associated with the located similar images, the system discerns a context for the uploaded image. The system then functions to make available to the user services, such as product recommendations, subscriptions, messaging, chatting, bulletin boards, links to information, etc., that are relevant to the context discerned for the uploaded image. The services made available to the user may also be centered around a particular community of users that are associated with the relevant context. Thus, by way of example considering an uploaded image that includes a book cover, unlike “snaptell.com” which merely provides information concerning the book object shown within the image the subject system and method functions to make available services relevant to a discerned context for the image, such as “library,” “book store,” or the like and/or community of users that are interested in libraries, book stores, etc.

While the forgoing provides a general explanation of the subject invention, a better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the subject invention, reference may be had to preferred embodiments shown in the attached drawings in which:

FIG. 1 illustrates in block diagram form components of an exemplary network system in which image data is used to provide services in connection with an online retail environment;

FIG. 2 illustrates in flow chart form an exemplary process by which image data uploaded to a system server is used to provide services in connection with an online retail environment; and

FIG. 3 illustrates in flow chart form an exemplary process by which image data associated with a user selected image is used to provide services in connection with an online retail environment.

### DETAILED DESCRIPTION

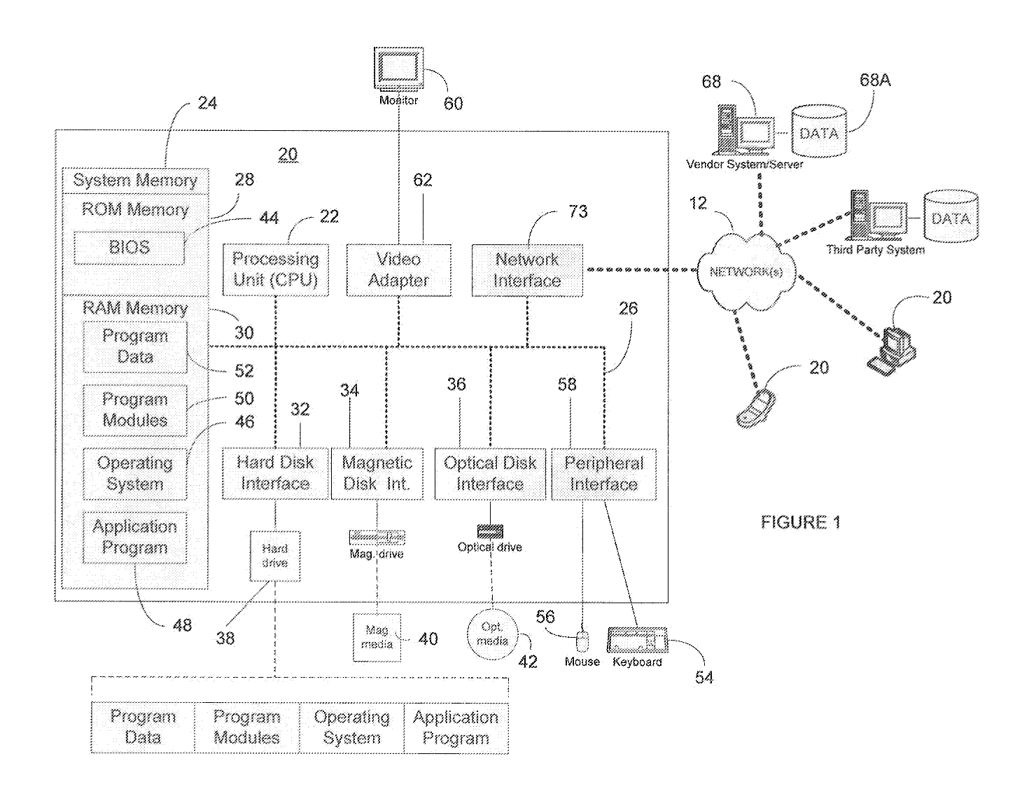

With reference to the figures, a system and method for using image data, e.g., video, photos, drawings, etc., to provide services in connection with an online retail environment is hereinafter described. In particular, as illustrated in FIG. 1, the system and method will be described in the context of a plurality of processing devices linked via a network, such as the World Wide Web or the Internet. In this regard, a processing device 20, illustrated in the exemplary form of a computer system, is provided with executable instructions to, for example, provide a means for a consumer, i.e., a user, to access a remote processing device, i.e., a vendor system server 68, and, among other things, upload and/or view images to thereby obtain access to contextually relevant online services. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

An end-user, e.g., a consumer, may enter commands and information into the processing device 20 through input devices such as a keyboard 54 and/or a pointing device 56. While not illustrated, other input devices may include a microphone, a joystick, a game pad, a scanner, a camera, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the vendor system server 68 having associated data repository 68A. In this regard, while the vendor system server 68 has been illustrated in the exemplary form of a computer, it will be appreciated that the vendor system server 68 may, like processing device 20, be any type of device having processing capabilities. Again, it will be appreciated that the vendor system server 68 need not be implemented as a single device but may be implemented in a manner such that the tasks performed by the vendor system server 68 are distributed to a plurality of processing devices linked through a communication network. Additionally, the vendor system server 68 may have logical connections to other third party servers via the network 12 and, via such connections, will be associated with data repositories that are associated with such other third party servers.

For performing tasks as needed, the vendor system server 68 may include many or all of the elements described above relative to the processing device 20. By way of further example, the vendor system server 68 includes the executable instructions for, among other things, handling search requests, providing search results, analyzing images and/or accessing the image analyzing capabilities of other websites, discerning image contexts, displaying images, providing access to context related services, etc. Communications between the processing device 20 and the vendor system server 68 may be exchanged via a further processing device, such as a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the vendor system server 68.

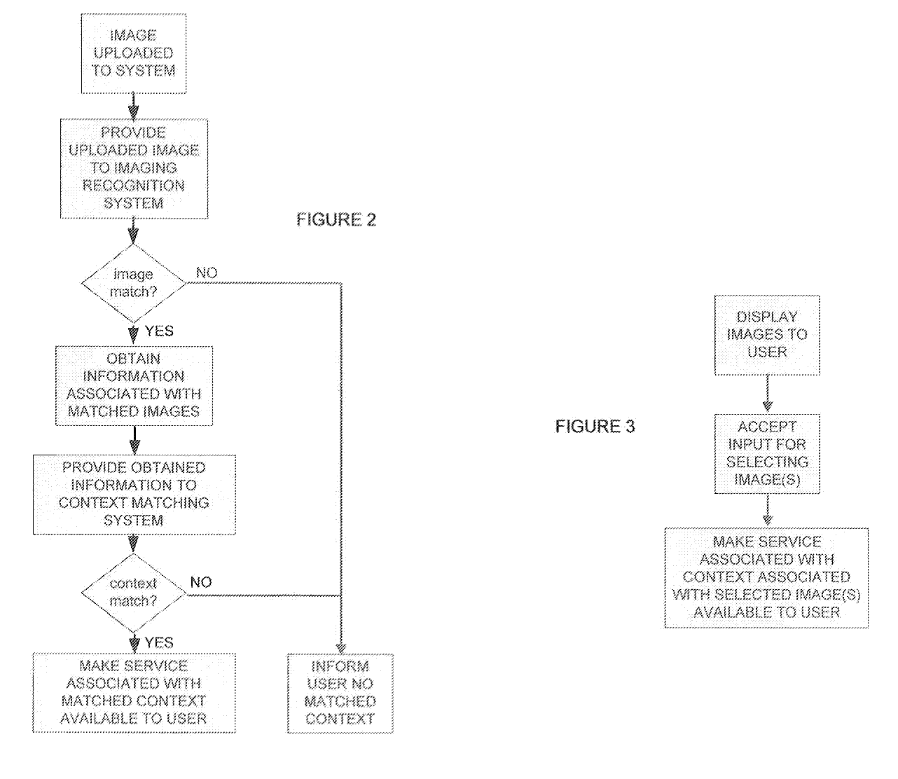

Turning now to FIG. 2, to provide context related services to a user via the vendor system server 68, the vendor system server 68 is generally adapted to receive images that are uploaded thereto from a processing device 20 via the network 12. As noted above, the vendor system server 68 then functions to discern from the data present in the image a context that is associated with the image. To this end, the vendor system server 68 accesses imaging technologies, whether located locally on the vendor system server 68 or on a third party system on the network, to have the uploaded image processed for the purpose of locating similar images, whether stored within the database 68A or other databases accessible via the network, and, thereafter, uses information that has been associated with the located similar images to discern a context for the image. The system may then make available to the user appropriate services, such as product recommendations, subscriptions, messaging, chatting, bulletin boards, links to information, etc., that are relevant to the context discerned for the uploaded image. The services made available to the user may also be centered around a particular community of users that are associated with the relevant context. Since the methods by which image recognition software may separate out (where necessary) and discern a match between a reference image and other images are well known, for example being described in U.S. Pat. Nos. 6,952,496, 6,763,148, 6,115,495, or 5,263,098, these methods will not be described further herein for the sake of brevity. Thus, it is understood that one skilled in the art of image recognition processing algorithms, techniques, and methods may implement an imaging system as described herein using ordinary skill and without undue experimentation.

By way of example of the system in use, a user may upload to the vendor system server 68 an image taken in a parking garage. The vendor system server 68 will then provide the uploaded image to an image recognition application which will function to locate similar images, e.g., images taken of parking garages. Associated with the matched images will be information describing or otherwise relevant to the matched images, such as meta-tag data, URL(s), directory name(s), file name(s), database name(s), weblink(s), information scrapped from a page or website containing a similar image, etc. The information associated with the matched images is then provided to the vendor system server 68 where the provided information is cross-referenced against a library of information that has been mapped within the vendor system server 68 to various contexts. Thus, using these steps, the vendor system server 68 can accept an uploaded image, use information previously associated with other images that are determined to be similar to the uploaded image to discern a context for the image, e.g., the image is a picture of a parking lot, a parking garage, a boiler room, a janitor's closet, a baseball park, etc, and provide to the user online services relevant to that context, e.g., recommendations for product that would be used in a parking garage, links to information about parking garage maintenance, access to parking garage maintenance message boards, etc. In some instances, the products to be recommended, the links to information, etc., may be obtained directly from the information associated with the images discerned to be a match for the uploaded information. The services that are ultimately made available to the user by use of the system, such as product recommendations, can be presented to the user via the vendor system server 68 in the manner that is illustrated and described in, for example, commonly assigned U.S. Application Nos. 2008/0228552 and 2006/0036510 as well as commonly assigned U.S. Pat. No. 7,323,536 which are each incorporated herein in their entirety by reference.

Turning now to FIG. 3, it will also be appreciated that the system may use a mapping between images and contexts to present to a user a gallery of images and, upon a user selecting one or more of the presented images, make available to a user services relevant to the context that was mapped to the image(s) so selected. As an example, a user can indicate a preference for “restaurants” whereupon the user will be presented with a gallery of restaurant images. Thereafter, upon the user indicating a preference for certain ones of the displayed images (e.g., selecting, spending time viewing, etc.), the user will be provided with recommendations for products to purchase that are most relevant to the context associated with the restaurant image(s) indicated by the user as being the best match for or “most like” their restaurant. In this regard, it will be appreciated that not all “restaurant” contexts will have the same product needs and a fast food or curbside restaurant will not use or need the same products as an upscale restaurant and, as such, upon a user indicating a preference for images depicting “fast food restaurant” contexts, the user will be presented with product purchasing opportunities that are most relevant to that user in that context.

While various concepts have been described in detail, it will be appreciated by those skilled in the art that various modifications and alternatives to those concepts could be developed in light of the overall teachings of the disclosure. For example, while the image recognition system has been described in the context of an algorithm that is used to locate one or more images that are similar to a reference image, it is to be understood that the image recognition system can equally use artificial intelligence algorithms to analyze features shown within an image, such as patterns, shapes, colors, etc., to thereby identify a context for that image, e.g., the artificial intelligence algorithms can identify yellow shaped arches within an image and thereby determine that the image is related to the “fast food restaurant” context. Further, while various aspects of this invention have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

1. A computer readable media embodied on a physical memory device having stored thereon computer executable instructions for providing product recommendations in connection with an online retail environment, the instructions, when executed by a computing device, performing steps comprising:
providing to an image recognition system a reference image;
causing the image recognition system to locate one or more images in a database that are similar to the reference image wherein the images in the database have associated information;
using the information associated with the one or more images in the database located by the image recognition system to discern an environmental context for the image; and
presenting to the user recommendations for products that are relevant to the discerned environmental context for the image.

2. The computer readable media as recited in claim 1, comprising presenting to the user links to information relevant to the discerned environmental context for the image.

3. The computer readable media as recited in claim 1, wherein the environmental context for the image is discerned by matching the information associated with the one or more images in the database located by the image recognition system with information stored within a database that has been cross-referenced to one or more environmental contexts.

4. The computer readable media as recited in claim 1, wherein the image recognition system and database of images are managed by a vendor of the products recommended to the user as being relevant to the discerned environmental context.

5. The computer readable media as recited in claim 1, wherein the image recognition system and database of images are managed by a third party that is unaffiliated with a vendor of the products recommended to the user as being relevant to the discerned environmental context.

6. The computer readable media as recited in claim 1, wherein the information associated with the images in the database is maintained in image meta-tags.

7. The computer readable media as recited in claim 1, wherein the information associated with the images in the database is scraped from a website at which the images are located.

8. A computer readable media embodied on a physical memory device having stored thereon computer executable instructions for providing product recommendations in connection with an online retail environment, the instructions, when executed by a computing device, performing steps comprising:
displaying to a user a plurality of images, each of the images having an environmental context associated therewith;
accepting input by which the user indicates a preference for one or more of the plurality of images; and
presenting to the user recommendations for products that are relevant to the environmental context associated with the one or more of the plurality of images preferred by the user.

9. A computer readable media embodied on a physical memory device having stored thereon computer executable instructions for providing product recommendations in connection with an online retail environment, the instructions, when executed by a computing device, performing steps comprising:
providing to an image recognition system a reference image;
causing the image recognition system to discern features within the reference, image;
using the features discerned within the reference image to discern an environmental context for the image; and
presenting to the user recommendations for products that are relevant to the discerned environmental context for the image.

10. The computer readable media as recited in claim 9, comprising presenting to the user links to information relevant to the discerned environmental context for the image.
